(19) United States
(12) Patent Application Publication
(10) Pub. No.: US 2026/0312895 A1
(43) Pub. Date: Oct. 8, 2026

(54) Data Analytics for Low Latency Low Loss Scalable Throughput

(71) Applicant: Telefonaktiebolaget LM Ericsson (publ), Stockholm (SE)

(72) Inventors: Julian Espinosa Santos, Madrid (ES); Ruth Pallares Del Egido, Madrid (ES); Miguel Angel Muñoz De La Torre Alonso, Madrid (ES)

(21) Appl. No.: 19/481,327

(22) PCT Filed: Jan. 2, 2024
(86) PCT No.: PCT/IB2024/050034

§ 371 Date: Nov. 4, 2025

(30) Foreign Application Priority Data
May 26, 2023 (EP) 23382493.7

(51) Int. Cl. H04L 43/062; H04L 43/026; H04L 47/31; H04W 8/22

(52) U.S. Cl. CPC H04L 43/062; H04L 43/026; H04L 47/31; H04W 8/22

(57) ABSTRACT

Definition of a new NWDAF (70) analytic for L4S allows a MNO to obtain L4S statistics and/or predictions related to L4S traffic and to act upon these new L4S statistics and predictions. The mechanism allows the MNO to support detection, monitoring and control of L4S traffic in a simple and efficient way, by identifying the amount of L4S enabled traffic in the network, which subscribers, devices, domains, applications and servers, etc. are L4S capable, and which ones are actually using L4S.

### TECHNICAL FIELD

The present disclosure relates generally to data analytics for wireless communication networks and. More particularly, to new data analytics for implementation of low latency low loss scalable (L4S) throughput technology in wireless communication networks

### BACKGROUND

L4S is a technology used in Internet Protocol (IP) networks to reduce queue delay problems, ensuring low latency to IP flows with a high throughput performance. To reach this goal, L4S relies on Explicit Congestion Notification (ECN), a mechanism that marks packets to signal congestion in the network avoiding packets to be dropped. The congestion signals are managed at the sender and receiver sides thanks to scalable congestion control algorithms.

There is an emerging interest in time-critical use cases in 5G networks, such as entertainment/multimedia, gaming, artificial reality (AR), virtual reality (VR), real-time video conferencing, vehicle to everything (V2X), teleoperated driving, etc.). These use cases require bounded low latency in conjunction with medium to high bitrates and the ability to scale across a large number of consumer devices. To meet this demand, entire networks must be optimized.

Recent enhancements like edge computing, 5G's new radio (NR) network interface, wider spectrum, and the possibility for shorter transmission time intervals (TTI) cannot fulfill the strict requirements for low latency applications alone, and new functionalities are needed to improve the quality of experience (QoE) for high data rate applications requiring bounded, stable, and low end-to-end latency. Accordingly, there is a need for methods to prevent latency spikes due to queuing delays. To fulfill latency requirements, an application must be able to adapt the bitrate to minimize the risk of increased delay while maximizing the service quality under this constraint.

It is expected L4S technology will be widely deployed in the coming years. During the transition period towards L4S broad adoption, mobile network operators (MNOs) will not be aware of the amount of traffic that is L4S capable and/or L4S enabled, or how it is impacting network resources. For example, when most UEs and applications support and request L4S, there is a risk of network resource exhaustion, which will negate the benefits of using L4.

### SUMMARY

The present disclosure relates to network analytics for L4S traffic in the wireless communication network. The definition of a new NWDAF analytic for L4S enables a mobile network operator (MNO) to obtain L4S statistics and/or predictions related to L4S traffic and to act upon these new L4S statistics and predictions. The mechanism herein described allows the MNO to support detection, monitoring and control of L4S traffic in a simple an efficient way, by identifying the amount of L4S enabled traffic in the network, which subscribers, devices, domains, applications and servers, etc. are L4S capable, and which ones are actually using L4S.

A first aspect of the disclosure comprises methods implemented by a network node in a wireless communication network of providing analytics reports for low latency low loss scalable (L4S) traffic in the wireless communication network. The method comprises receiving, from a requesting node, a request for L4S analytics associated with L4S traffic in the wireless communication network. The method further comprises collecting, from one or more network nodes, protocol metric data associated with one or more detected packet flows in the wireless communication network, the protocol metric data including, for each of one or more detected packet flows, an indication whether the packet flow is L4S enabled. The method further comprises generating, based on the collected protocol metric data, an L4S analytics report including at least one analytic result for the L4S traffic in the wireless communication network. The method further comprises sending, to the requesting node responsive to the request, the L4S analytics report.

A second aspect of the disclosure comprises a network node configured to provide analytics reports for low latency low loss scalable (L4S) traffic in the wireless communication network. The network node is configured to receive, from a requesting node, a request for L4S analytics associated with L4S traffic in the wireless communication network. The network node is further configured to collect, from one or more network nodes, protocol metric data associated with one or more detected packet flows in the wireless communication network. The protocol metric data including, for each of one or more detected packet flows, an indication whether the packet flow is L4S enabled. The network node is further configured to generate, based on the collected protocol metric data, an L4S analytics report including at least one analytic result for the L4S traffic in the wireless communication network. The network node is further configured to send, to the requesting node responsive to the request, the L4S analytics report.

A third aspect of the disclosure comprises a network node configured to provide analytics reports for low latency low loss scalable (L4S) traffic in the wireless communication network. The network node comprises communication circuitry configured for communication with one or more other network nodes and processing circuitry operatively connected to the communication circuitry. The processing circuitry is configured to receive, from a requesting node, a request for L4S analytics associated with L4S traffic in the wireless communication network. The processing circuitry is further configured to collect, from one or more network nodes, protocol metric data associated with one or more detected packet flows in the wireless communication network, the protocol metric data including, for each of one or more detected packet flows, an indication whether the packet flow is L4S enabled. The processing circuitry is further configured to generate, based on the collected protocol metric data, an L4S analytics report including at least one analytic result for the L4S traffic in the wireless communication network. The processing circuitry is further configured to send, to the requesting node responsive to the request, the L4S analytics report.

A fourth aspect of the disclosure comprises a computer program for a network node. The computer program comprises executable instructions that, when executed by processing circuitry in a network node in a communication network, causes the network node to perform the method according to the first aspect.

A fifth aspect of the disclosure comprises a carrier containing a computer program according to the fourth aspect. The carrier is one of an electronic signal, optical signal, radio signal, or a non-transitory computer readable storage medium.

A sixth aspect of the disclosure comprises methods implemented by a network node in a wireless communication network of collecting data for low latency low loss scalable (L4S) traffic in the wireless communication network. The method comprises receiving, from a requesting node, a request for protocol metric data, the request including user equipment (UE) identification for one or more target UEs. The method further comprises detecting packet flows in the wireless communication network associated with the target UEs. The method further comprises providing protocol metric data for each of one or more detected packet flows to the requesting node, the protocol metric data including an indication, for each of one or more of the detected packet flows, whether the packet flow is L4S enabled.

A seventh aspect of the disclosure comprises a network node configured to collect data for low latency low loss scalable (L4S) traffic in the wireless communication network. The network node is configured to receive, from a requesting node, a request for protocol metric data associated with user plane traffic, the request including user equipment (UE) identification for one or more target UEs. The network node is further configured to detect packet flows in the wireless communication network associated with the target UEs. The network node is further configured to provide protocol metric data for the detected packet flows to the requesting node, the protocol metric data including an indication, for each of one or more of the detected packet flows, whether the packet flow is L4S enabled.

An eighth aspect of the disclosure comprises a network node configured to manage resources for low latency low loss scalable (L4S) traffic in the wireless communication network. The network node comprises communication circuitry configured for communication with one or more other network nodes and processing circuitry operatively connected to the communication circuitry. The processing circuitry is configured to receive, from a requesting node, a request for protocol metric data associated with user plane traffic, the request including user equipment (UE) identification for one or more target UEs. The processing circuitry is further configured to detect packet flows in the wireless communication network associated with the target UEs. The processing circuitry is further configured to provide protocol metric data for the detected packet flows to the requesting node, the protocol metric data including an indication, for each of one or more of the detected packet flows, whether the packet flow is L4S enabled.

A ninth aspect of the disclosure comprises a computer program for a network node. The computer program comprises executable instructions that, when executed by processing circuitry in a network node in a communication network, causes the network node to perform the method according to the sixth aspect.

A tenth aspect of the disclosure comprises a carrier containing a computer program according to the ninth aspect. The carrier is one of an electronic signal, optical signal, radio signal, or a non-transitory computer readable storage medium.

An eleventh aspect of the disclosure comprises methods implemented by a network node in a wireless communication network of managing low latency low loss scalable (L4S) traffic in the wireless communication network. The method comprises sending, to a data analytics network node, a request for L4S analytics associated with L4S traffic in the wireless communication network. The method further comprises receiving, from a data analytics node responsive to the request, generating, a L4S analytics report including at least one analytic result for the L4S traffic in the wireless communication network. The method further comprises performing a network function to manage L4S traffic and/or resources used by L4S traffic based on the analytic result.

A twelfth aspect of the disclosure comprises a network node configured to manage low latency low loss scalable (L4S) traffic in the wireless communication network. The network node is configured to send, to a data analytics network node, a request for L4S analytics associated with L4S traffic in the wireless communication network. The network node is further configured to receive, from a data analytics node responsive to the request, generating, an L4S analytics report including at least one analytic result for the L4S traffic in the wireless communication network. The network node is further configured to perform a network function to manage L4S traffic and/or resources used by L4S traffic based on the analytic result.

A thirteenth aspect of the disclosure comprises a network node configured to manage low latency low loss scalable (L4S) traffic in the wireless communication network. The network node comprises communication circuitry configured for communication with one or more other network nodes and processing circuitry operatively connected to the communication circuitry. The processing circuitry is configured to t send, to a data analytics network node, a request for L4S analytics associated with L4S traffic in the wireless communication network. The processing circuitry is further configured to receive, from a data analytics node responsive to the request, generating, an L4S analytics report including at least one analytic result for the L4S traffic in the wireless communication network. The processing circuitry is further configured to perform a network function to manage L4S traffic and/or resources used by L4S traffic based on the analytic result.

A fourteenth aspect of the disclosure comprises a computer program for a network node. The computer program comprises executable instructions that, when executed by processing circuitry in a network node in a communication network, causes the network node to perform the method according to the eleventh aspect.

A fifteenth aspect of the disclosure comprises a carrier containing a computer program according to the fourteenth aspect. The carrier is one of an electronic signal, optical signal, radio signal, or a non-transitory computer readable storage medium.

### BRIEF DESCRIPTION OF THE DRAWINGS

FIG. 1 illustrates logical network functions in a core network of a communication network.

FIG. 2 is a schematic diagram illustrating an implementation of L4S analytics in a wireless communication network.

FIGS. 3A-3C illustrate an exemplary procedure for providing L4S network analytics to a consumer network function.

FIG. 4 illustrates an exemplary method implemented by a producer network node in a wireless communication network of providing L4S analytics services for user equipment (UEs) to a consumer network node.

FIG. 5 illustrates an exemplary method implemented by a user plane network node in a wireless communication network of collecting and providing data of L4S analytics.

FIG. 6 illustrates an exemplary method implemented by a consumer network node in a wireless communication network of obtaining L4S analytics for UEs In the wireless communication network.

FIG. 7 illustrates an exemplary network node according to an embodiment.

FIG. 8 illustrates an exemplary network node according to an embodiment.

FIG. 9 illustrates an exemplary network node according to an embodiment.

FIG. 10 illustrates an exemplary network node that can be configured as a producer network node in a wireless communication network, a consumer network node, a user plane network node, or any combination thereof.

### DETAILED DESCRIPTION

Referring now to the drawings, an exemplary embodiment of the disclosure will be described in the context of a Fifth Generation (5G) communication network. Those skilled in the art will appreciate that the methods and apparatus herein described are not limited to use in 5G networks but may also be used in communication networks operating according to other standards that use a service-based architecture.

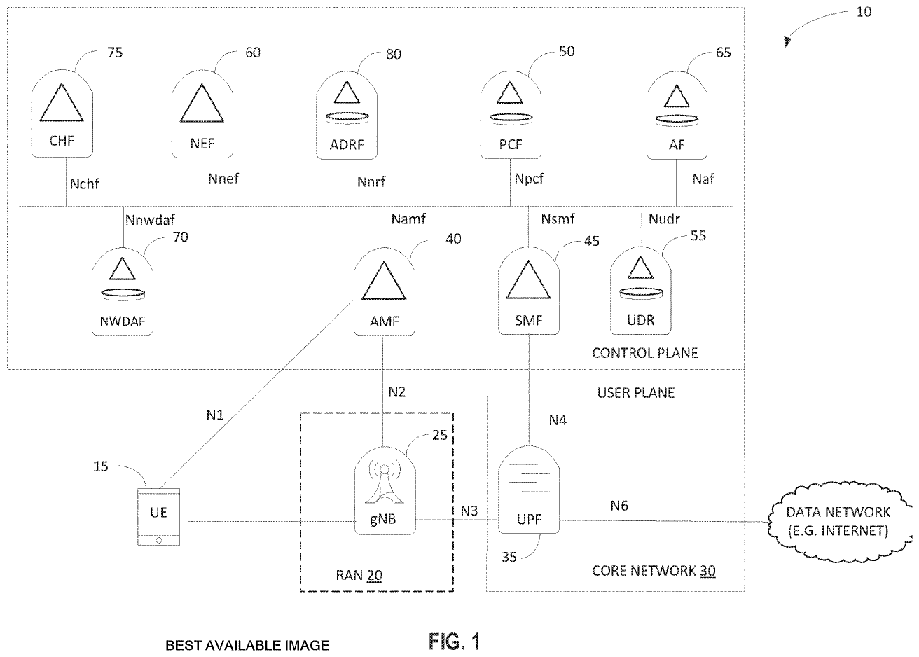

FIG. 1 illustrates a wireless communication network 10 according to one exemplary embodiment. The wireless communication network 10 comprises a 5G radio access network (RAN) 20 and a core network 30 employing a service-based architecture. The RAN 20 comprises one or more base stations 25 providing radio access to UEs 15 operating in the communication network 10. The base stations 25 are also referred to in applicable standards as gNodeBs (gNBs). The UEs 15 may comprise cellular phones, smart phones, tablets, laptop computers, or other electronic devices with communication capabilities. The core network 30, referred to herein as a 5G Core (5GC), provides a connection between the RAN 20 and other packet data networks, such as the Internet Protocol (IP) Multimedia Subsystem (IMS) or the Internet. Those skilled in the art will appreciate that other types of RANs in addition to the 5G RAN 20 can connect to the 5GC 30. For example, an Evolved Universal Mobile Telecommunications System (UMTS) Terrestrial Radio Access (EUTRA) base station in an Evolved UMTS Terrestrial Radio Access Network (EUTRAN) may also connect to the 5GC 30.

The 5GC 30 comprises a number of Network Function (NFs). These NFs include a User Plane Function (UPF) 35, Access and Mobility Management Function (AMF) 40, Session Management Function (SMF) 45, a Policy Control Function (PCF) 50, a Unified Data Repository (UDR) 55, a Network Exposure Function (NEF) 60, an Application Functions (AFs) 65 (which may be located in the core network 30 or be external to the core network 30), a Network Data Analytics function (NWDAF) 70, and a Charging Function (CHF) 75. Some Embodiments may further include a Analytics Data Repository Function (ADRF) 80.

The NFs shown in FIG. 1 comprise logical entities that reside in one or more core network nodes, which may be implemented by one or more processors, hardware, firmware, or a combination thereof. The NFs may reside in a single core network node or may be distributed among two or more core network nodes. Further, the network 10 may include multiple instances of the NFs.

In conventional communication network, the various NFs (e.g., UPF 35, SMF 45, AMF 40, PCF 50, etc.) in the 5GC 30 communicate with one another over predefined interfaces. In the service-based architectures shown in FIG. 1, the 5GC 30 uses a services model in which the NFs query a Network Repository Function (NRF) (not shown) or other NF discovery node to discover and communicate with each other. The UPF 35, however, is an exception and uses a pre-defined interface called the N4 interface to communicate with the SMF 45. The NFs can subscribe to receive notification 10 services and data from other NFs. In this context, the NF providing the service or data is referred to as a service producer and the NF receiving the data and reports is referred to as a service consumer.

The most relevant NFs for purposes of this disclosure are the NWDAF 70, UDR 55, PCF 50, SMF 45, and UPF 35.

The NWDAF 70 according to 3GGP standards is a service producer because it generates analytic reports used by consumer NFs. The consumer NFs within the 5GC 30 use the Nnwdaf interface to send subscription requests for analytics reports to the NWDAF 70. The requests may specify a group of UEs 15 for which data is requested. For example, a consumer NF may request a predicted future trajectory for a group of UEs 15, an activity pattern for the group of UEs 15 services used by the UEs 15, etc. The NWDAF 70 receives subscription requests for analytic data from consumer NFs (e.g., AMF 40, SMF 45, PCF 50) over the Nnwdaf interface, compiles the requested data and generates analytics reports for the UEs 15 identified in the request. The analytic reports can be sent periodically or responsive to a triggering event.

The UDR 55 stores data grouped into distinct collections of subscription-related information. The stored data can include subscription data, policy data, structured data for exposure, and application data.

The PCF 50 supports a unified policy framework to govern the network behavior. Specifically, the PCF 50 provides Policy and Charging Control (PCC) rules to the Policy and Charging Enforcement Function (PCEF), i.e., the SMF 50/UPF 35 that enforces policy and charging decisions according to provisioned PCC rules.

The UPF 35 supports handling of user plane traffic, including packet inspection, packet routing and forwarding, traffic usage reporting, QoS handling.

One aspect of the present disclosure is to provide data analytics for Low Latency Low Loss Scalable Throughput (L4S) traffic in the wireless communication network. L4S is a technology used in Internet Protocol (IP) networks to reduce queue delay problems, ensuring low latency to IP flows with a high throughput performance. To reach this goal, L4S relies on Explicit Congestion Notification (ECN), a mechanism that marks packets to signal congestion in the network avoiding packets to be dropped. The congestion signals are managed at the sender and receiver sides thanks to scalable congestion control algorithms.

The ECN bits and their corresponding codepoints are shown in table below:

| Binary codepoint | Codepoint name | Meaning |
|---|---|---|
| 00 | Non-ECT | Not ECN-capable transport |
| 01 | ECT (1) | L4S-capable transport |
| 10 | ECT (0) | ECN-capable transport |
| 11 | CE | Congestion experienced |

L4S is described in Request For Comments (RFCs) published by the Internet Engineering Task Force (IETF). In particular, L4S is described in RFCs 9330, 9331, and 9332.

There is an emerging interest in time-critical use cases in 5G networks, such as entertainment/multimedia, gaming, artificial reality (AR), virtual reality (VR), real-time video conferencing, vehicle to everything (V2X), teleoperated driving, etc.). These use cases require bounded low latency in conjunction with medium to high bitrates and the ability to scale across a large number of consumer devices. To meet this demand, entire networks must be optimized.

Recent enhancements like edge computing, 5G's new radio (NR) network interface, wider spectrum, and the possibility for shorter transmission time intervals (TTI) cannot fulfill the strict requirements for low latency applications alone, and new functionalities are needed to improve the quality of experience (QoE) for high data rate applications requiring bounded, stable, and low end-to-end latency. Accordingly, there is a need for methods to prevent latency spikes due to queuing delays. To fulfill latency requirements, an application must be able to adapt the bitrate to minimize the risk of increased delay while maximizing the service quality under this constraint.

This rate adaptation in 5G networks can be achieved by L4S, a mechanism being standardized in the Internet Engineering Task Force (IETF) that reduces latency for traffic.

It is expected L4S technology will be widely deployed in the coming years. During the transition period towards L4S broad adoption, mobile network operators (MNOs) will not be aware of the amount of traffic that is L4S capable and/or L4S enabled, or how it is impacting network resources. For example, when most UEs and applications support and request L4S, there is a risk of network resource exhaustion, which will negate the benefits of using L4.

One aspect of the disclosure comprises a mechanism which allows the network operator to detect, monitor and control L4S related traffic in a simple and efficient way, based on Analytics (NWDAF). The mechanism is based on the definition of a new NWDAF analytic for L4S, which allows the MNO to obtain L4S statistics and/or predictions related to L4S traffic and to act upon these new L4S statistics and predictions. The mechanism herein described allows the network operator to support detection, monitoring and control of L4S traffic in a simple an efficient way, by identifying the amount of L4S enabled traffic in the network, which subscribers, devices, domains, applications and servers, etc. are L4S capable, and which ones are actually using L4S.

As an example, L4S enabled traffic in the network representing a significant amount of the total traffic (e.g., 50% of the total traffic is L4S) suggests the need to control this traffic by taking traffic management actions, such as splitting traffic according to categories and applying specific policies in order to provide a desired Quality of Service (QoS) for a certain application. Further, the mechanism described herein allows the operator to identify which subscribers and terminals are L4S capable or have L4S enabled in their sessions, so the traffic management actions can be applied on a per individual basis. Another advantage, apart from L4S related statistics, is the ability to obtain L4S related predictions.

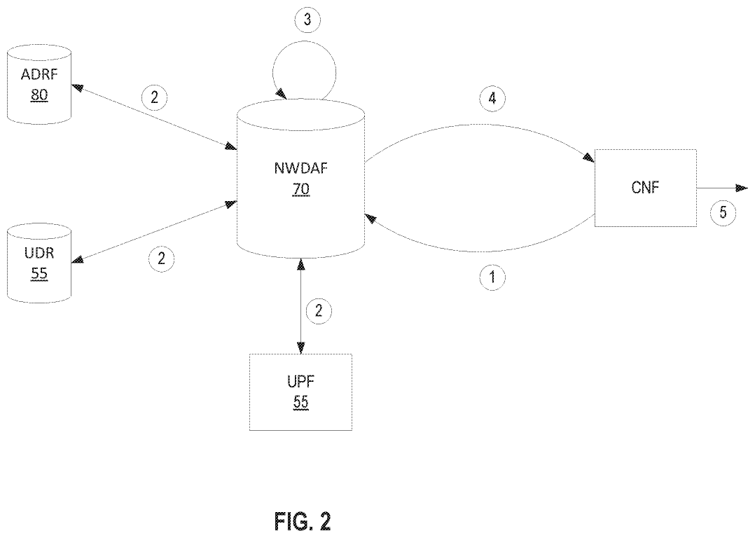

FIG. 2 is a schematic diagram illustrating an implementation of L4S analytics in a wireless communication network. FIG. 2 illustrates data collection for a single UE 15 with the understanding that a similar process is performed for many UEs 15. A consumer NF (CNF) subscribes to a new L4S analytic identified, for example, by the Analytic ID=L4S (1). The subscription is triggered by sending an analytics subscription request (Nnwdaf_AnalyticsSubcriptionRequest) to the NWDAF 70. The analytics subscription request includes the Analytic ID=L4S and optionally a list of UEs targeted by the request. The targeted UEs can be identified by a UE-ID, a list of UE-IDs, a Group ID, a list of Group IDs, an indication of any UE (i.e., all UEs), or some combination thereof. When identification of the targeted UEs is omitted, the data collection and analytics are applied to all UEs (any UEs).

In some embodiments, the analytics subscription request may further include one or more event filters that constrains the analytics to a defined subset of the targeted UEs, a particular type of traffic, a geographic area, or some combination thereof. As one example, the filter criteria may comprise an application ID (App ID), Service Data Flow (SDF) ID, or other information that indicates a traffic type. When no indication of the traffic type is given, the data collection and analytics are applied to all traffic types. As another example, the filter criteria may comprise an indication of a service area or domain, such as a Data Network Name (DNN), a Single—Network Slice Selection Assistance Information (S=NSSAI), an Area of Interest.

In some embodiments, the filter criteria may apply to a specific Radio Access Technology (RAT) type (e.g., 5G, 4G, etc.), for which L4S analytics are needed or to a specific time period (day, week, month, etc.).

In some embodiments, the analytics subscription request may include a confidence level to indicate a required confidence level from the CNF.

Based on the analytic subscription from the CNF, NWDAF 70 triggers data collection from the UPF 35 and optionally the UDR 55 (2). The NWDAF 70 may also collect historical L4S analytics from an ADRF 80. Depending on the event filters and UE target identifiers, the UPF 35 collects protocol metric data for one or more detected packet flows and returns the collected data to the NWDAF 70. Some of the collected data may be pre-processed by the UPF 35. Examples of the protocol metric data returned by the UPF 35 includes, for each detected packet flow:
Timestamp (start and stop)
Volume (e.g., in bytes) of the flow
Data rate (e.g., in kbps) of the flow
QoS Flow Identifier (QFI) assigned to the flow. This parameter can be used to indicate the QoS resources assigned to the flow.
5-tuple (source IP address and port, and destination IP address and port, protocol of the flow)
Indication of the flow being L4S enabled (or not). Alternatively, the UPF 35 can forward detected ECN bits or ECN codepoints.
Indication of which endpoint/s (client or server side) is/are supporting and requesting L4S. This allows e.g. to identify the L4S endpoints capabilities.
Indication of which ECN based mechanism is used: L4S, classic ECN or none.
Indication of the congestion status changes over the flow lifecycle (e.g., a flow starts with ECN=01 and then goes to ECN=11 or vice versa) together with the entity providing the indication (access node or core end-point).
App-ID or SDF-ID. This parameter identifies an application or service
Type of traffic. This parameter can be used to identify which type of traffic for a specific application that is L4S enabled (where App ID=Whatsapp, traffic type=video)
Domain name(s) associated with endpoints.

The L4S related information (e.g., ECN bits) reported in the proposed UPF event refers to the inner header (i.e., the IP headers exchanged between client and server, that is, ECN marked by the endpoints). Reporting can be extended to include the ECN time sequence series related information (N3, N9) for the outer header (i.e. the GTP header), which only applies in 5GC transport not beyond N6 that is not GTP tunneled, and to get the full scenario (as UPF sees both inner and outer headers).

The indication whether a packet flow is UE enabled or UE capable may be an explicit indication, such as a flag. Alternatively, the UPF 35 may report the detected ECN bits or ECN code points in the IP header as a time series. For example, the UPF could send an elaborated time sequence series with the relevant ECN bit (or ECN codepoint) changes over the course of the packet flow, e.g. up to a certain configurable number of packets, in both uplink (UL) and downlink (DL) directions. This avoids sending a potentially large number of data (e.g. in case of large flows).

In addition to data collection from the UPF 35, the NWDAF 70 may also collect data from the UDR 55 and/or ADRF 80. The UDR 55 stores subscriber data, including L4S related policies. An example of a L4S policy is triggering a new QoS flow for every L4S enabled packet flow. The ADRF 80 can, in some embodiments, store historic results for L4S analytics for a subscriber, which can be used by the NWDAF 70.

Based on the data collected from the UPF 35, UDR 55, and/or ADRF 80, NWDAF 70 runs analytic processes and generates the analytic result (3). The analytic results can include the following information as a non-limiting example:
List of UE-IDs. This list identifies UE-IDs with L4S enabled traffic flows. The UE-ID may comprise, for example, the subscriber identifier (SUPI/IMSI), the subscriber public identifier (PUI/MSISDN) and/or device identifier (PEI/IMEI).
List of App-IDs. This list identifies the App-IDs for which L4S enabled traffic has been found.
(Optional) List of Server IP addresses. This list identifies Server IPs for which L4S enabled traffic has been found.
(Optional) List of Domain names. This list identifies the Domain names for which L4S enabled traffic has been found.
(Optional) L4S volume. The parameter can include the amount of the L4S enabled traffic flow of the percentage of the L4S enabled with respect to the total traffic volume. The L4S volume can be provided on a global, per application, or per UE basis.
(Optional) Confidence metric. A ratio or percentage that indicates the confidence of the L4S analytic result.
(Optional) Recommended traffic management action. Can be provided where the NWDAF 70 determines that L4S enabled traffic is over a certain configured threshold and/or the confidence level is high. As one example, the MWDAF may recommend updating L4S related policies.

The NWDAF 70 returns the analytic result to the requesting CNF (4).

Based on the analytic-result returned by the NWDAF 70, the CNF (e.g., PCF 50) may take a traffic management action or resource management action to manage network resources (5). The traffic management action may be an action recommended by the NWDAF 70, or an action determined independently by the CNF. An example of a traffic management action is updated a policy for L4S traffic.

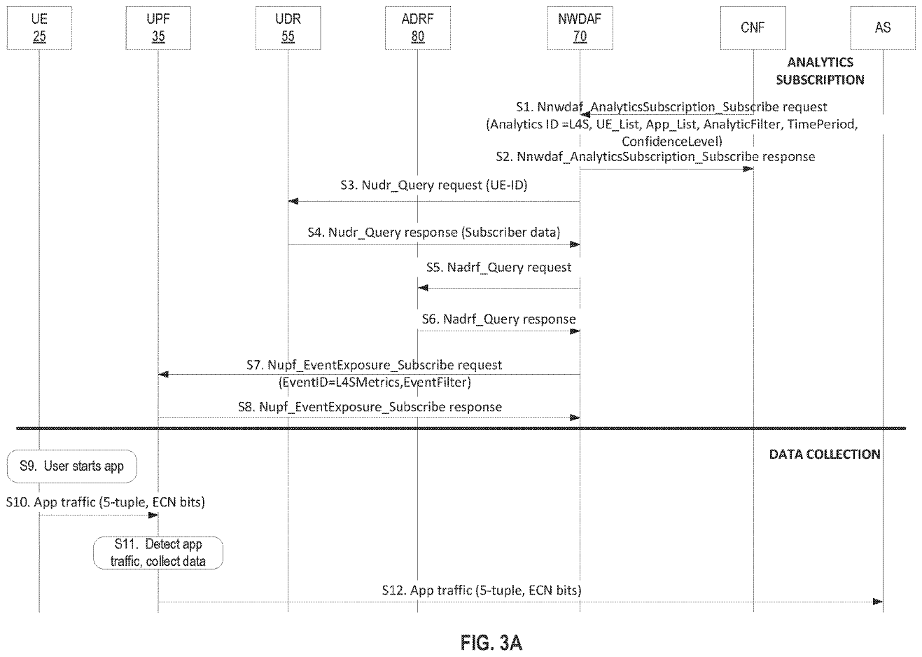

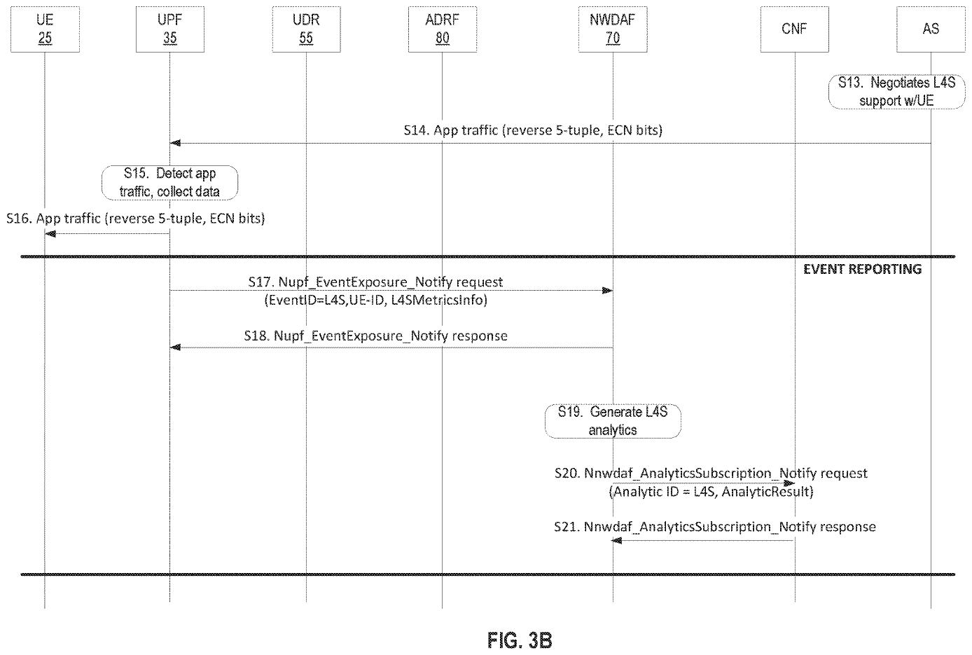

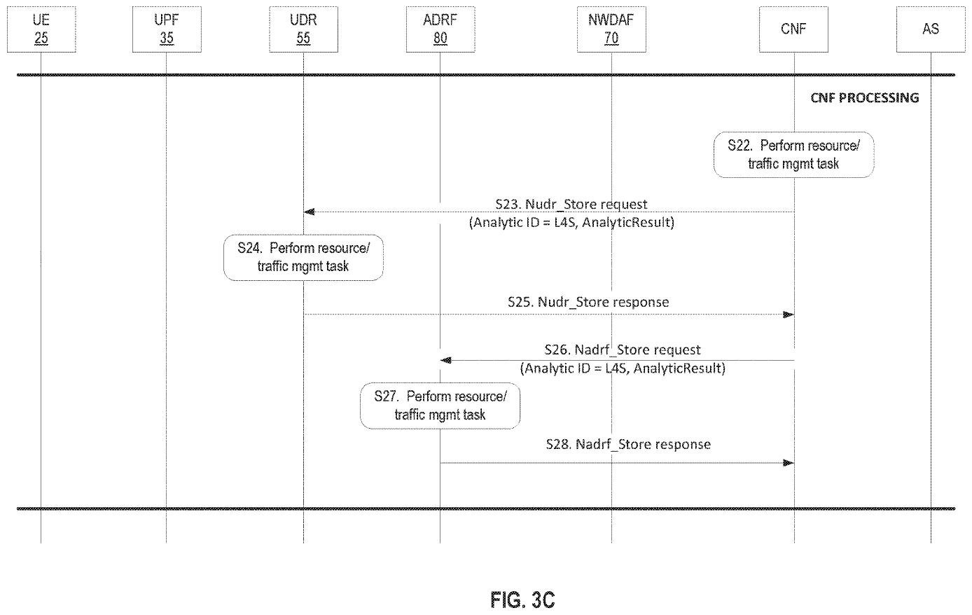

FIGS. 3A-3C illustrate an exemplary signaling flow for providing L4S network analytics to a consumer network function. A CNF subscribes to NWDAF 70 to receive L4S analytics (Analytic-ID=L4S) by sending an analytics subscription request message (Nnwdaf_AnalyticsSubscription_Subscribe) to the NWDAF 70 (S1). The analytics subscription request may include AnalyticsID=L4S, a list of target UEs, a list of target applications, one or more analytics filters, a time period of interest, and a confidence level. The NWDAF 70 answers the request message with a response message accepting the subscription or indicating success (S2).

After accepting the subscription request from the CNF, the NWDAF 70 initiates data collection (S3-S8). The NWDAF 70 triggers data collection from the UDR 55 by sending a query request (Nudr_Query) to the UDR 55 requesting subscriber data for the targeted UEs 15 (S3). The UDR 55 answers the request with a response including the requested subscriber data, including L4S related policies for the targeted UEs 15 (S4). The NWDAF 70 triggers data collection from the ADRF 80 by sending a query request (NADRF 80_Query) to the ADRF 80 requesting subscriber data for the targeted UEs 15 (S5). The ADRF 80 answers the request with a response including historic L4S analytic results for the targeted UEs 15 (S6). Finally, the NWDAF 70 triggers data collection from the UPF 35 by sending an event exposure subscription request (Nupf_EventExposure_Subscription) to the UPF 35 to obtain L4S related information for user plane traffic detected by the UPF for the targeted UEs 15 (S7). The UPF 35 answers the subscription request with a response with a response message accepting the subscription or indicating success (S8).

After accepting the subscription to event reporting from the NWDAF 70, the UPF 35 begins data collection. An application client running on a UE 15 initiates an application and negotiates L4S support with the application server (S9). The UE 15 sends application traffic towards the application server (S10). The packet flow includes IP packets with IP headers containing a 5-tuple and ECN bits). The UPF 35 detects the application traffic from the UE 15, collects data for Event ID=L4S metrics as described above, and forwards the application traffic towards the application server (S11, S12). The application server negotiates L4S support with the application client at the UE 15 and sends application traffic back toward the UE 15 (S13, S14). The UPF 35 detects the application traffic from the application server, collects data for Event ID=L4S metrics as described above, and forwards the application traffic towards the UE 15 (S15, S16). The UPF 35 continues collecting data for a determined period of time or until a predetermined event has occurred.

After passage of the predetermined period of time, or responsive to a predetermined event, the UPF 35 reports data for Event ID=L4S metrics to the NWDAF 70 by sending a notification message (Nupf_EventExposure_Notify) to the NWDAF 70 (S17). The notification message includes the L4S metrics collected by the UPF a previously described. The NWDAF 70 answers the notification message with a response indicated successful receipt of the notification message (S18).

Based on the data collected from UDR 55, ADRF 80 and UPF 35, the NWDAF 70 runs analytic processes and generates an L4S analytic result as described above (S19). The NWDAF 70 sends the L4S analytic result to the CNF in a notification message (Nnwdaf_AnalyticsSubscription_Notify) (S20). The CNF answers the notification message with a response indicated successful receipt of the notification message (S21).

The CNF performs a traffic management action or resource management action based on the analytic result (S22). In some cases, the analytic result, which may be performed by the CNF. Alternatively, the CNF may determine a different traffic/resource management action. As an example, where the CNF is a PCF 50, the PCF 50 may update L4S related policies for existing Packet Data Unit (PDU) sessions. Assuming that a dedicated QoS flow is active for L4S enabled flows for a user's PDU session, the PCF 50 could update the PCC rules to deactivate the dedicated QoS flow. Deactivation of QoS flows can be performed for a specific UE or a specific group of UEs 15. In one embodiment, the PCF 50 may deactivate dedicated QoS flows associated with certain subscriber groups (e.g., Bronze subscribers).

The recommended action, or independently determined action, may be performed conditionally based on an L4S statistic, L4S prediction, and/or a confidence level of the analytic result. For example, if the volume of L4S traffic meets a threshold and the confidence level is high, the PCF 50 or other CNF make perform the traffic/resource management action.

Continuing with the example of a PCF 50 as the CNF, any changes made to the L4S policy needs to be uploaded to the UDR 55. In the event of a change in the L4S policy, the PCF 50 upload the change to the UDR 55 by sending a store request (Nudr_Store) containing the policy update to the UDR 55 (S23). The UDR 55 stores the updated L4S policy and answers the store request with a response indicating the successful policy update (S24, S25). The (updated) L4S related policies stored in UDR can be used in subsequent user PDU sessions.

In some embodiments, the CNF, or alternatively the NWDAF 70, may store the analytic result with the ADRF 80. The CNF, or NWDAF 70 sends a store request (NADRF 80_Store) containing the analytic result to the ADRF 80 (S26). The ADRF 80 stores the analytic result and answers the store request with a response indicating the successful uploading (S27, S28). The L4S related analytic results stored in ADRF 80 can be used in subsequent L4S related analytic requests by the same or any other consumer.

The new NWDAF analytic related to L4S allows the mobile network operator (MNO) to obtain an analytic result related to L4S traffic in the form of L4S statistics and/or predictions and to act upon the analytic result to manage L4S traffic and better utilize network resources.

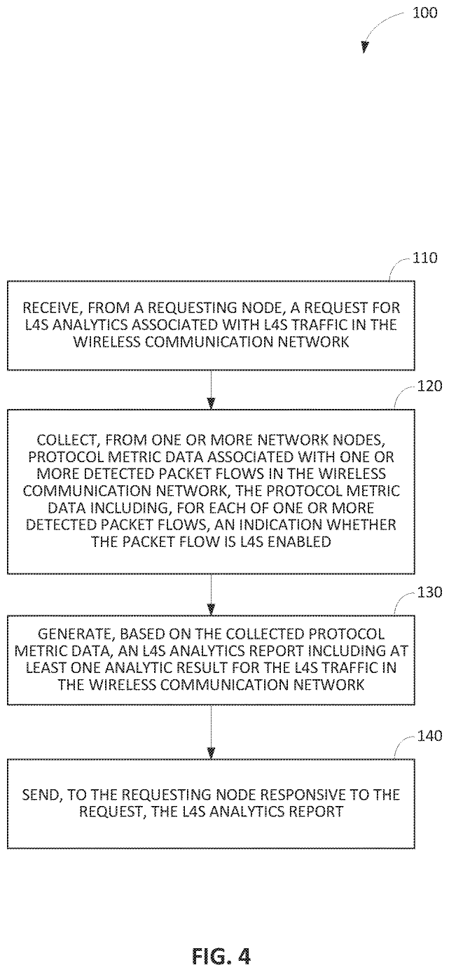

FIG. 4 illustrates an exemplary method 100 implemented by a producer network node in a wireless communication network of providing L4S analytics services for user equipment (UEs) to a consumer network node. The method 100 comprises receiving, from a requesting node, a request for L4S analytics associated with L4S traffic in the wireless communication network (block 110). The method 100 further comprises collecting, from one or more network nodes, protocol metric data associated with one or more detected packet flows in the wireless communication network (block 120). The protocol metric data includes, for each of one or more detected packet flows, an indication whether the packet flow is L4S enabled. The method 100 further comprises generating, based on the collected protocol metric data, an L4S analytics report including at least one analytic result for the L4S traffic in the wireless communication network (block 130). The method 100 further comprises sending, to the requesting node responsive to the request, the L4S analytics report (block 140).

In some embodiments of method 100, the request includes an identification of one or more target UEs.

Some embodiments of method 100 further comprise determining, for each of L4S enabled packet flows, a user equipment identifier associated with the L4S enabled packet flow.

In some embodiments of method 100, the indication comprises an explicit indication, such as a flag, indicating whether the flow is L4S enabled.

In some embodiments of method 100, the indication comprises Explicit Congestion Notification (ECN) bits extracted from one or more packets contained in the packet flow.

In some embodiments of method 100, the protocol metric data further includes a flow identifier for the packet flow.

In some embodiments of method 100, the protocol metric data further includes an indication of the L4S capabilities for one or more endpoints of the enabled packet flows.

In some embodiments of method 100, (ECN) mechanism used for the packet flows.

In some embodiments of method 100, the protocol metric data further includes an indication of congestion status changes of the packet flows over time.

In some embodiments of the method 100, the protocol metric data further includes one or more of a time stamp associated with the packet flow, a data rate of the packet flow, a volume of the traffic flow, a type of the traffic flow, an application identifier associated with the traffic flow, a source address, destination address, and protocol associated with the packet flow, or a domain associated with the traffic flow, In some embodiments of the method 100, the analytics result comprises a list of UEs associated with the L4S traffic.

In some embodiments of method 100, the analytics result comprises a list of applications associated with the L4S traffic.

In some embodiments of method 100, the analytics result comprises a list of application servers associated with the L4S traffic.

In some embodiments of method 100, the analytics result comprises a list of domains associated with the L4S traffic.

In some embodiments of method 100, the analytics result comprises an indication of L4S traffic volume.

In some embodiments of method 100, the analytics result comprises a confidence level indicative of the reliability of the analytic result.

In some embodiments of method 100, the analytics result comprises a recommended action.

In some embodiments of the method 100, the request further comprises an event filter and wherein the network node collects protocol metric data for packet flows meeting the event filter:

Some embodiments of the method 100 further comprise obtaining subscriber data for one or more target UEs identified in the request, the subscriber data including L4S related policies for one or more of the target UEs.

Some embodiments of method 100 further comprise obtaining historical results for L4S analytics for one or more target UEs identified in the request.

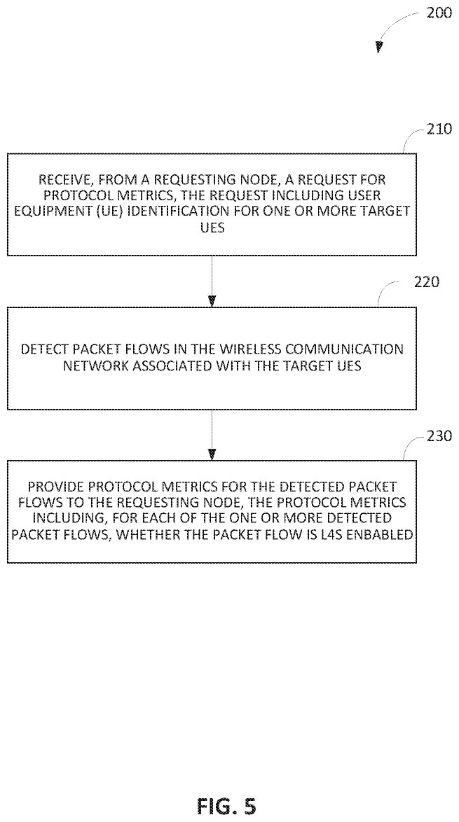

FIG. 5 illustrates an exemplary method 200 implemented by a user plane network node in a wireless communication network of collecting and providing data of L4S analytics. Method 200 comprises receiving, from a requesting node, a request for protocol metric data, the request including user equipment (UE) identification for one or more target UEs (block 210). The method 200 further comprises detecting packet flows in the wireless communication network associated with the target UEs (block 220). The method 200 further comprises providing protocol metric data for each of one or more detected packet flows to the requesting node (block 230). The protocol metric data includes an indication, for each of one or more of the detected packet flows, whether the packet flow is L4S enabled.

Some embodiments of method 200 further comprise providing to the requesting node, for each of one or more packet flows, a user equipment identifier associated with the packet flow.

In some embodiments of the method 200, the indication comprises a flag indicating whether the flow is L4S enabled.

In some embodiments of method 200, the indication comprises Explicit Congestion Notification (ECN) bits extracted from one or more packets contained in the packet flow. indicated whether the flow is L4S enabled.

In some embodiments of method 200, the protocol metric data further includes a flow identifier for the packet flow.

In some embodiments of method 200, the protocol metric data further includes an indication of the L4S capabilities for one or more endpoints of the enabled packet flows.

In some embodiments of method 200, the protocol metric data further includes an indication of an Explicit Congestion Notification (ECN) mechanism used for the packet flows.

In some embodiments of method 200, the protocol metric data further includes an indication of congestion status changes of the packet flows over time.

In some embodiments of the method 200, the protocol metric data further include, for each of one or more packet flows, one or more of a time stamp associated with the packet flow, a data rate of the packet flow, a volume of the traffic flow, a type of the traffic flow, an application identifier associated with the traffic flow, a source address, destination address, and protocol associated with the packet flow, or a domain associated with the traffic flow, In some embodiments of the method 200, the analytics result comprises a list of UEs associated with the L4S traffic.

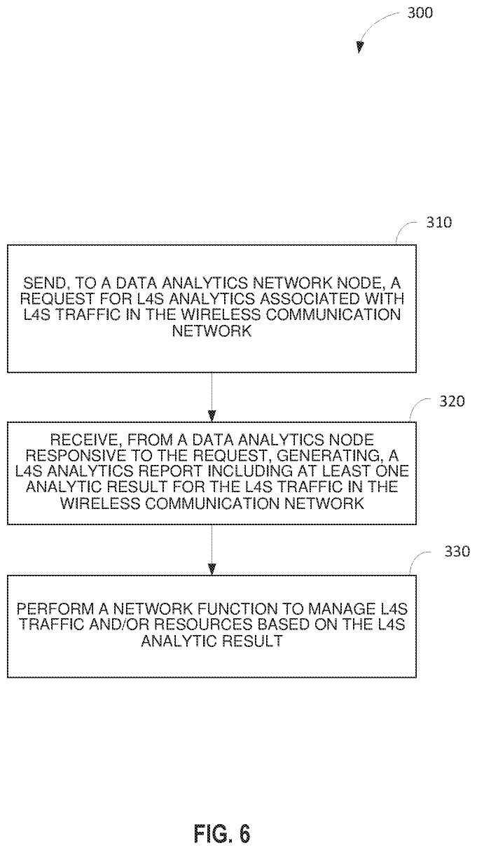

FIG. 6 illustrates an exemplary method 300 implemented by a consumer network node in a wireless communication network of managing L4S traffic in the wireless communication network. Method 300 comprises sending, to a data analytics network node, a request for L4S analytics associated with L4S traffic in the wireless communication network (block 310). The method 300 further comprises receiving, from a data analytics node responsive to the request, a L4S analytics report including at least one analytic result for the L4S traffic in the wireless communication network (block 320). The method 300 further comprises performing a network function to manage L4S traffic and/or resources used by L4S traffic based on the analytic result (block 330).

In some embodiments of method 300, the request includes an identification of one or more target UEs.

In some embodiments of method 300, the analytics result comprises a list of UEs associated with the L4S traffic.

In some embodiments of method 300, the analytics result comprises a list of applications associated with the L4S traffic.

In some embodiments of method 300, the analytics result comprises a list of application servers associated with the L4S traffic.

In some embodiments of method 300, the analytics result comprises a list of domains associated with the L4S traffic.

In some embodiments of method 300, the analytics result comprises an indication of L4S traffic volume.

In some embodiments of method 300, the analytics result comprises a confidence level indicative of the reliability of the analytic result.

In some embodiments of method 300, the analytics result comprises a recommended action.

An apparatus can perform any of the methods herein described by implementing any functional means, modules, units, or circuitry. In one embodiment, for example, the apparatuses comprise respective circuits or circuitry configured to perform the steps shown in the method figures. The circuits or circuitry in this regard may comprise circuits dedicated to performing certain functional processing and/or one or more microprocessors in conjunction with memory. For instance, the circuitry may include one or more microprocessor or microcontrollers, as well as other digital hardware, which may include Digital Signal Processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory may include program instructions for executing one or more telecommunications and/or data communications protocols as well as instructions for carrying out one or more of the techniques described herein, in several embodiments. In embodiments that employ memory, the memory stores program code that, when executed by the one or more processors, carries out the techniques described herein.

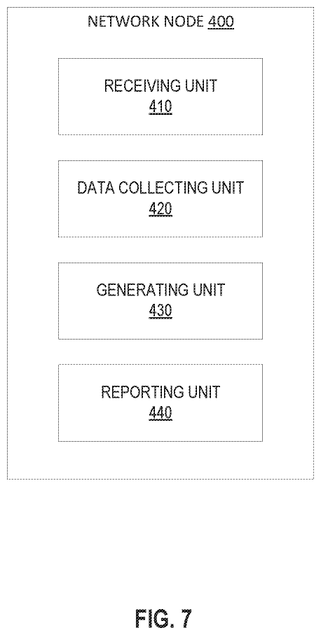

FIG. 7 illustrates an exemplary network node 400 configured to perform the method 100 shown in FIG. 4. The network node 400 comprises a receiving unit 410, a data collection unit 420, a generating unit 430, and a reporting unit 440. The various units 410-440 can be implemented by hardware and/or by software code that is executed by a processor or processing circuit. The receiving unit 410, is configured to receive, from a requesting node, a request for L4S analytics associated with L4S traffic in the wireless communication network. The data collecting unit 420 is configured to detect collect, from one or more network nodes, protocol metric data associated with one or more detected packet flows in the wireless communication network. The protocol metric data including, for each of one or more detected packet flows, an indication whether the packet flow is L4S enabled. The generating unit 430 is configured to generate, based on the collected protocol metric data, an L4S analytics report including at least one analytic result for the L4S traffic in the wireless communication network. The reporting unit 440 is configured to send, to the requesting node responsive to the request, the L4S analytics report.

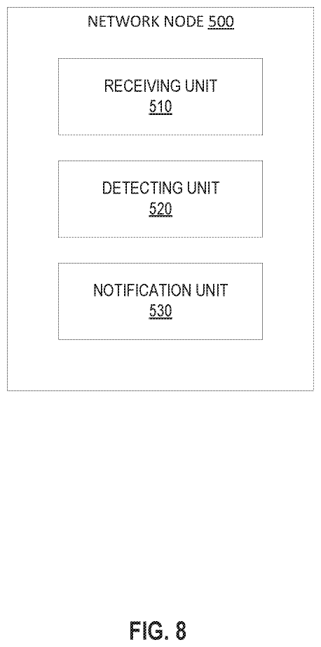

FIG. 8 illustrates an exemplary network node 500 configured to perform the method 100 shown in FIG. 5. The network node 500 comprises a receiving unit 510, a detection unit 520, and a notification unit 530. The various units 510-530 can be implemented by hardware and/or by software code that is executed by a processor or processing circuit. The receiving unit 510, is configured to receive, from a requesting node, a request for protocol metric data associated with user plane traffic, the request including user equipment (UE) identification for one or more target UEs. The detecting unit 520 is configured to detect packet flows in the wireless communication network associated with the target UEs. The notification unit 530 is configured to provide protocol metric data for the detected packet flows to the requesting node, the protocol metric data including an indication, for each of one or more of the detected packet flows, whether the packet flow is L5S enabled.

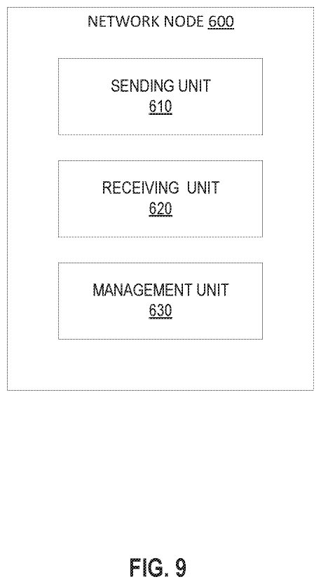

FIG. 9 illustrates an exemplary network node 600 configured to perform the method 100 shown in FIG. 6. The network node 600 comprises a sending unit 610, a receiving unit 620, and a managing unit 630. The various units 610-630 can be implemented by hardware and/or by software code that is executed by a processor or processing circuit. The sending unit 610 is configured to send, to a data analytics network node, a request for L4S analytics associated with L4S traffic in the wireless communication network. The receiving unit 620 is configured to receive, from a data analytics node responsive to the request, generating, an L4S analytics report including at least one analytic result for the L4S traffic in the wireless communication network. The managing unit 630 is configured to perform a network function to manage L4S traffic and/or resources used by L4S traffic based on the analytic result.

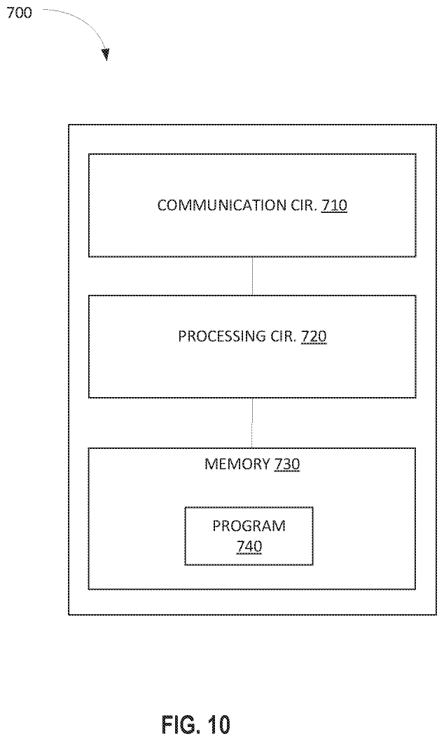

FIG. 10 illustrates the main functional components of another exemplary network node 700 that can be configured to perform any one of the methods shown in FIGS. 4-7. The network node 700 comprises communication circuitry 710, processing circuitry 720, and memory 730.

Communication circuitry 710 comprises network interface circuitry for communicating with other core network nodes over a communication network, such as an Internet Protocol (IP) network.

Processing circuitry 720 controls the overall operation of the network node 700 and is configured to perform one or more of the methods 100, 200, and 300 shown in FIGS. 4-7 respectively. The processing circuitry 720 may comprise one or more microprocessors, hardware, firmware, or a combination thereof. The processing circuitry can be configured by software to perform one or more of the methods 100, 200, 300 shown in FIGS. 4-6 respectively.

Memory 730 comprises both volatile and non-volatile memory for storing computer program code and data needed by the processing circuitry 720 for operation. Memory 730 may comprise any tangible, non-transitory computer-readable storage medium for storing data including electronic, magnetic, optical, electromagnetic, or semiconductor data storage. Memory 730 stores a computer program 740 comprising executable instructions that configure the processing circuitry 720 to implement one or more of the methods 100, 200, and 300 shown in FIGS. 4-6 respectively. A computer program in this regard may comprise one or more code modules corresponding to the means or units described above. In general, computer program instructions and configuration information are stored in a non-volatile memory, such as a ROM, erasable programmable read only memory (EPROM) or flash memory. Temporary data generated during operation may be stored in a volatile memory, such as a random access memory (RAM). In some embodiments, computer program 740 for configuring the processing circuitry 720 as herein described may be stored in a removable memory, such as a portable compact disc, portable digital video disc, or other removable media. The computer program 740 may also be embodied in a carrier such as an electronic signal, optical signal, radio signal, or computer readable storage medium.

Those skilled in the art will also appreciate that embodiments herein further include corresponding computer programs. A computer program comprises instructions which, when executed on at least one processor of an apparatus, cause the apparatus to carry out any of the respective processing described above. A computer program in this regard may comprise one or more code modules corresponding to the means or units described above.

Embodiments further include a carrier containing such a computer program. This carrier may comprise one of an electronic signal, optical signal, radio signal, or computer readable storage medium.

In this regard, embodiments herein also include a computer program product stored on a non-transitory computer readable (storage or recording) medium and comprising instructions that, when executed by a processor of an apparatus, cause the apparatus to perform as described above.

Embodiments further include a computer program product comprising program code portions for performing the steps of any of the embodiments herein when the computer program product is executed by a computing device. This computer program product may be stored on a computer readable recording medium.

1-58. (canceled)

59. A method implemented by a network node in a wireless communication network (10) of providing analytics reports for low latency low loss scalable (L4S) traffic in the wireless communication network, the method comprising:
receiving, from a requesting node, a request for L4S analytics associated with L4S traffic in the wireless communication network;
collecting, from one or more network nodes, protocol metric data associated with one or more detected packet flows in the wireless communication network, the protocol metric data including, for each of one or more detected packet flows, an indication whether the packet flow is L4S enabled;
generating, based on the collected protocol metric data, an L4S analytics report including at least one analytic result for the L4S traffic in the wireless communication network; and
sending, to the requesting node responsive to the request, the L4S analytics report.

60. The method of claim 59, wherein the request includes an identification of one or more target UEs.

61. The method of claim 59, further comprising determining, for each of L4S enabled packet flows, a user equipment identifier associated with the L4S enabled packet flow.

62. The method of claim 59, wherein the indication comprises a flag indicating whether the flow is L4S enabled and/or Explicit Congestion Notification (ECN) bits extracted from one or more packets contained in the packet flow.

63. The method of claim 62, wherein the protocol metric data further includes one or more of:
flow identifier for the packet flow;
an indication of the L4S capabilities for one or more endpoints of the enabled packet flows;
an indication of an Explicit Congestion Notification (ECN) mechanism used for the packet flows;
an indication of congestion status changes of the packet flows over time;
a time stamp associated with the packet flow;
a data rate of the packet flow
a volume of the traffic flow;
a type of the traffic flow;
an application identifier associated with the traffic flow;
a source address, destination address, and protocol associated with the packet flow; or
a domain associated with the traffic flow;

64. The method of claim 59, wherein the analytics result comprises one or more of:
a list of UEs associated with the L4S traffic;
a list of applications associated with the L4S traffic;
a list of application servers associated with the L4S traffic;
a list of domains associated with the L4S traffic;
an indication of L4S traffic volume;
a confidence level indicative of the reliability of the analytic result;
a recommended action.

65. The method of claim 59, wherein the request further comprises an event filter and wherein the network node collects protocol metric data for packet flows meeting the event filter:

66. The method of claim 59, further comprising obtaining subscriber data for one or more target UEs identified in the request, the subscriber data including L4S related policies for one or more of the target UEs

67. The method of claim 59, further comprising obtaining historical results for L4S analytics for one or more target UEs identified in the request.

68. A method implemented by a network node in a wireless communication network of collecting data for low latency low loss scalable (L4S) traffic in the wireless communication network, the method comprising:
receiving, from a requesting node, a request for protocol metric data, the request including user equipment (UE) identification for one or more target UEs;
detecting packet flows in the wireless communication network associated with the target UEs;
providing protocol metric data for each of one or more detected packet flows to the requesting node, the protocol metric data including an indication, for each of one or more of the detected packet flows, whether the packet flow is L4S enabled.

69. The method of claim 68, further comprising providing to the requesting node, for each of one or more packet flows, a user equipment identifier associated with the packet flow.

70. The method of claim 68, wherein the indication comprises a flag indicating whether the flow is L4S enabled and/or Explicit Congestion Notification (ECN) bits extracted from one or more packets contained in the packet flow. indicated whether the flow is L4S enabled.

71. The method of claim 68, wherein the protocol metric data further include, for each of one or more packet flows, one or more of:
flow identifier for the packet flow;
an indication of the L4S capabilities for one or more endpoints of the enabled packet flows;
an indication of an Explicit Congestion Notification (ECN) mechanism used for the packet flows;
an indication of congestion status changes of the packet flows over time;
a time stamp associated with the packet flow;
a data rate of the packet flow;
a volume of the traffic flow;
a type of the traffic flow;
an application identifier associated with the traffic flow;
a source address, destination address, and protocol associated with the packet flow; or
a domain associated with the traffic flow;

72. A method implemented by a network node in a wireless communication network of managing L4S traffic in the wireless communication network, the method (300) comprising:
sending, to a data analytics network node, a request for L4S analytics associated with L4S traffic in the wireless communication network;
receiving, from a data analytics node responsive to the request, generating, a L4S analytics report including at least one analytic result for the L4S traffic in the wireless communication network; and
performing a network function to manage L4S traffic and/or resources used by L4S traffic based on the analytic result.

73. The method of claim 72, wherein the request includes an identification of one or more target UEs.

74. The method of claim 72, wherein the analytics result comprises one or more of:
a list of UEs associated with the L4S traffic;
a list of applications associated with the L4S traffic;
a list of application servers associated with the L4S traffic;
a list of domains associated with the L4S traffic;
an indication of L4S traffic volume;
a confidence level indicative of the reliability of the analytic result;
a recommended action.

75. A network node in a wireless communication network configured to manage low latency, low loos scalable (L4S) traffic; the network node being configured to:
communication circuitry configured for communication with one or more other network nodes;
processing circuitry operatively connected to the communication circuitry and configured to:
receive, from a requesting node, a request for protocol metric data associated with user plane traffic, the request including user equipment (UE) identification for one or more target UEs;
detect packet flows in the wireless communication network associated with the target UEs;
provide protocol metric data for the detected packet flows to the requesting node, the protocol metric data including an indication, for each of one or more of the detected packet flows, whether the packet flow is L4S enabled.
